(19) United States
(12) Patent Application Publication
(10) Pub. No.: US 2012/0173184 A1
(43) Pub. Date: Jul. 5, 2012

(54) DEPTH SENSOR, DEFECT CORRECTION METHOD THEREOF, AND SIGNAL PROCESSING SYSTEM INCLUDING THE DEPTH SENSOR

(75) Inventors: Ilia Ovsiannikov, Studio City, CA (US); Dong Ki Min, Seoul (KR)

(73) Assignee: SAMSUNG ELECTRONICS CO., LTD., Suwon-si (KR)

(21) Appl. No.: 13/297,851

(22) Filed: Nov. 16, 2011

(30) Foreign Application Priority Data
Jan. 5, 2011 (KR) 10-2011-0000952

(51) Int. Cl. G06F 19/00; G01P 21/00

(52) U.S. Cl. 702/97; 73/1.81

(57) ABSTRACT

The defect correction method includes arranging a plurality of neighbor depth pixel information values of respective neighbor depth pixels, comparing a depth pixel information value of a depth pixel with a reference value, which is one of the arranged neighbor depth pixel information values, and correcting the depth pixel information value according to a comparison result.

### CROSS-REFERENCE TO RELATED APPLICATIONS

This application claims priority under 35 U.S.C. §119 to the benefit of Korean Patent Application No. 10-2011-0000952, filed on Jan. 5, 2011, in the Korean Intellectual Property Office, the entire disclosure of which is incorporated herein by reference.

### BACKGROUND

Some embodiments relate to a depth sensor using a time-of-flight (TOF) principle, and more particularly, to a depth sensor for correcting a defect, a method thereof, and/or a signal processing system including the depth sensor.

Depth images are obtained using a depth sensor using the TOF principle. The depth images may include noise. Accordingly, a method of reducing pixel noise by detecting and correcting defective pixels is desired.

### SUMMARY

Some embodiments provide a depth sensor for detecting and correcting a defective pixel, a method thereof, and/or a signal processing system including the depth sensor.

According to an example embodiment, there is provided a defect correction method for a depth sensor. The defect correction method includes the operations of arranging a plurality of neighbor depth pixel information values of respective neighbor depth pixels. The neighbor depth pixels neighbor a depth pixel. The method further includes comparing a depth pixel information value of the depth pixel with a reference value. The reference value is one of the arranged neighbor depth pixel information values. The depth pixel information value is corrected according to a comparison result.

The depth pixel information value and the neighbor depth pixel information values may be one of phase difference values, differential depth pixel signal values, offset values, and amplitude values. A plurality of first pixel signals are detected at a first detection point, a plurality of second pixel signals are detected at a second detection point, a plurality of third pixel signals are detected at a third detection point, and a plurality of fourth pixel signals are detected at a fourth detection point. The differential depth pixel signal values may be one of (1) first differential pixel signal values obtained by subtracting the plurality of second pixel signals detected at the second detection point from the plurality of fourth pixel signals detected at the fourth detection point among the plurality of pixel signals detected at the depth pixel and the neighbor depth pixels; and (2) second differential pixel signal values obtained by subtracting the plurality of first pixel signals detected at the first detection point from the plurality of third pixel signals detected at the third detection point among the plurality of pixel signals detected at the depth pixel and the neighbor depth pixels.

The reference value may include one of a first reference value and a second reference value. The first reference value may be one of first through third values among the neighbor depth pixel information values arranged in descending order. The second reference value may be one of first through third values among the neighbor depth pixel information values arranged in ascending order.

The operation of correcting the depth pixel information value may include replacing the depth pixel information value with the first reference value when the depth pixel information value is greater than the first reference value.

The operation of correcting the depth pixel information value may include one of (1) maintaining the depth pixel information value and (2) replacing the depth pixel information value with a mean of values between the first reference value and the second reference value among the arranged neighbor depth pixel information values when the depth pixel information value is less than the first reference value.

The operation of correcting the depth pixel information value may include one of (1) maintaining the depth pixel information value and (2) replacing the depth pixel information value with a mean of values between the first reference value and the second reference value among the arranged neighbor depth pixel information values when the depth pixel information value is greater than the second reference value.

The operation of correcting the depth pixel information value may include replacing the depth pixel information value with the second reference value when the depth pixel information value is less than the second reference value.

In another example embodiment, the method includes arranging a plurality of neighbor depth pixel information values for a plurality of neighbor depth pixels. The neighbor depth pixels neighbor a depth pixel. The method further includes determining at least one reference value based on the arranged plurality of neighbor depth pixels information values, and correcting a depth information value of the depth pixel based on the reference value.

According to another example embodiment, there is provided a depth sensor including a light source configured to emit modulated light to a target object; a depth pixel and neighbor depth pixels. The neighbor depth pixels neighbor the depth pixel. The depth pixel and the neighbor depth pixel are each configured to detect a plurality of pixel signals at different detection points according to light reflected from the target object. A digital circuit is configured to convert the plurality of pixel signals into a plurality of digital pixel signals. A pixel information generator is configured to generate a depth pixel information value of the depth pixel and a plurality of neighbor depth pixel information values of the respective neighbor depth pixels using the plurality of digital pixel signals. A defect correction filter is configured to arrange the neighbor depth pixel information values, compare the depth pixel information value with a reference value which is one of the arranged neighbor depth pixel information values, and correct the depth pixel information value according to a comparison result.

According to another example embodiment, there is provided a signal processing system including the above-described depth sensor and a processor configured to control an operation of the depth sensor.

### BRIEF DESCRIPTION OF THE DRAWINGS

The above and other features and advantages of the embodiments will become more apparent by describing in detail exemplary embodiments thereof with reference to the attached drawings in which:

FIG. 1 is a block diagram of a depth sensor according to an example embodiment;

FIG. 2 is a plan view of a 2-tap depth pixel included in an array illustrated in FIG. 1;

FIG. 3 is a cross-sectional view of the 2-tap depth pixel illustrated in FIG. 2, taken along the line III-III′;

FIG. 4 is a timing chart of photo gate control signals for controlling photo gates included in the 2-tap depth pixel illustrated in FIG. 1;

FIG. 5 is a timing chart for explaining a plurality of pixel signals sequentially detected using the 2-tap depth pixel illustrated in FIG. 1;

FIG. 6 is a block diagram of a plurality of pixels illustrated in FIG. 1;

FIG. 7 is a diagram showing phase difference values of respective neighbor depth pixels of a depth pixel;

FIG. 8 is a flowchart of a defect correction method of a depth sensor according to an example embodiment;

FIG. 9 is a diagram of a unit pixel array of a three-dimensional (3D) image sensor according to an example embodiment;

FIG. 10 is a diagram of a unit pixel array of a 3D image sensor according to an example embodiment ;

FIG. 11 is a block diagram of a 3D image sensor according to an example embodiment;

FIG. 12 is a block diagram of an image processing system including the 3D image sensor illustrated in FIG. 11;

FIG. 13 is a block diagram of an image processing system including a color image sensor and the depth sensor illustrated in FIG. 1; and

FIG. 14 is a block diagram of a signal processing system including the depth sensor illustrated in FIG. 1.

### DETAILED DESCRIPTION OF THE EMBODIMENTS

The embodiments now will be described more fully hereinafter with reference to the accompanying drawings, in which embodiments are shown. This embodiments may, however, be embodied in many different forms and should not be construed as limited to the embodiments set forth herein. Rather, these embodiments are provided so that this disclosure will be thorough and complete, and will fully convey the scope of the inventive concepts. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

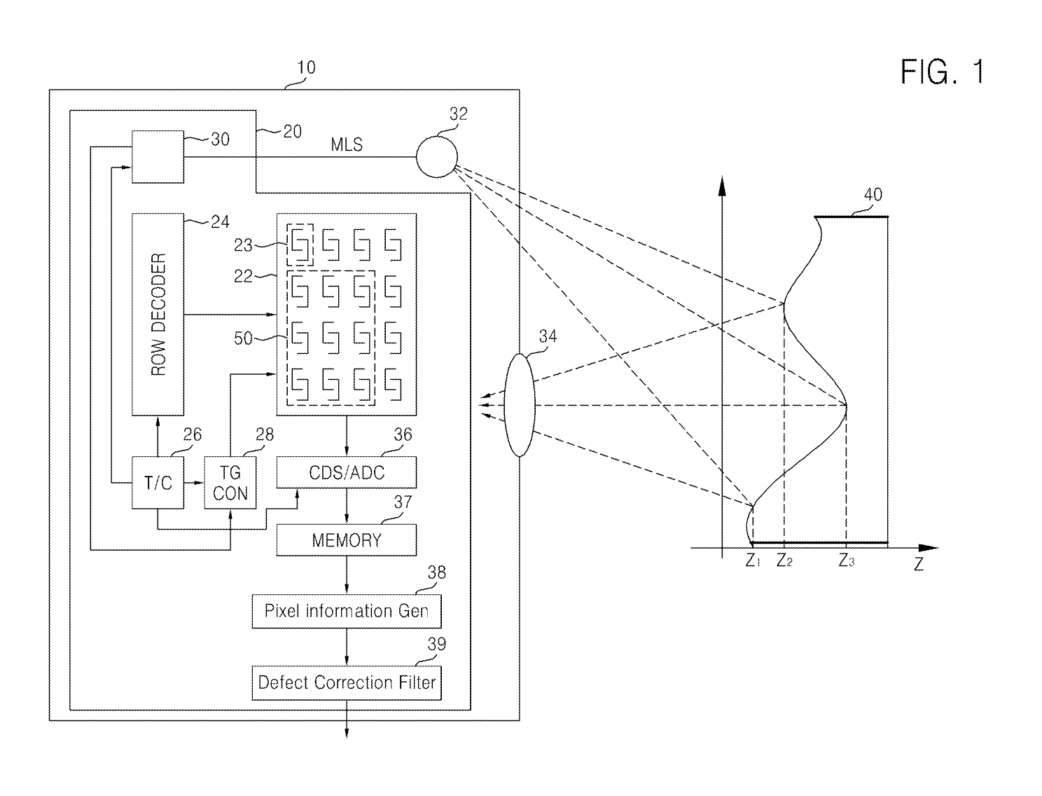

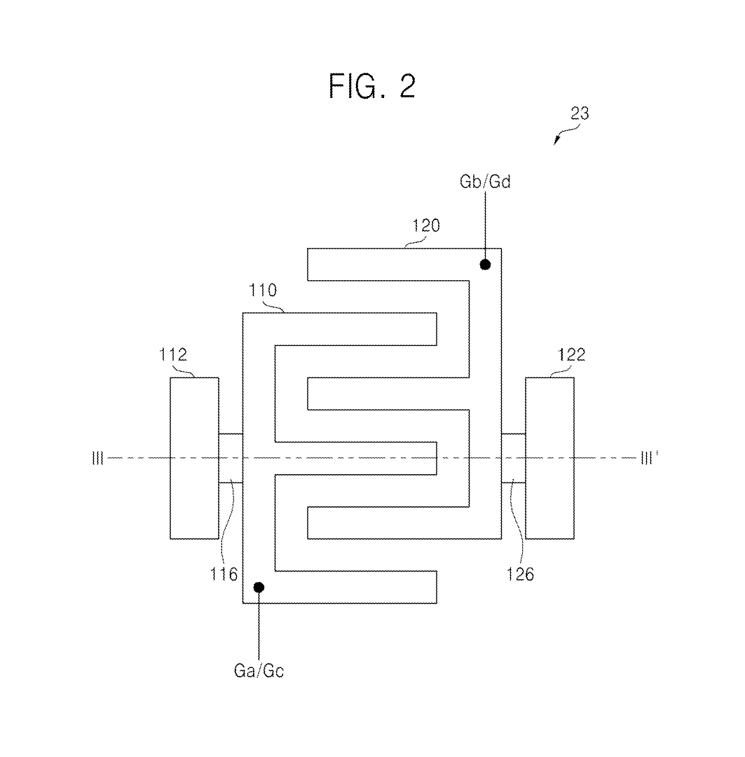

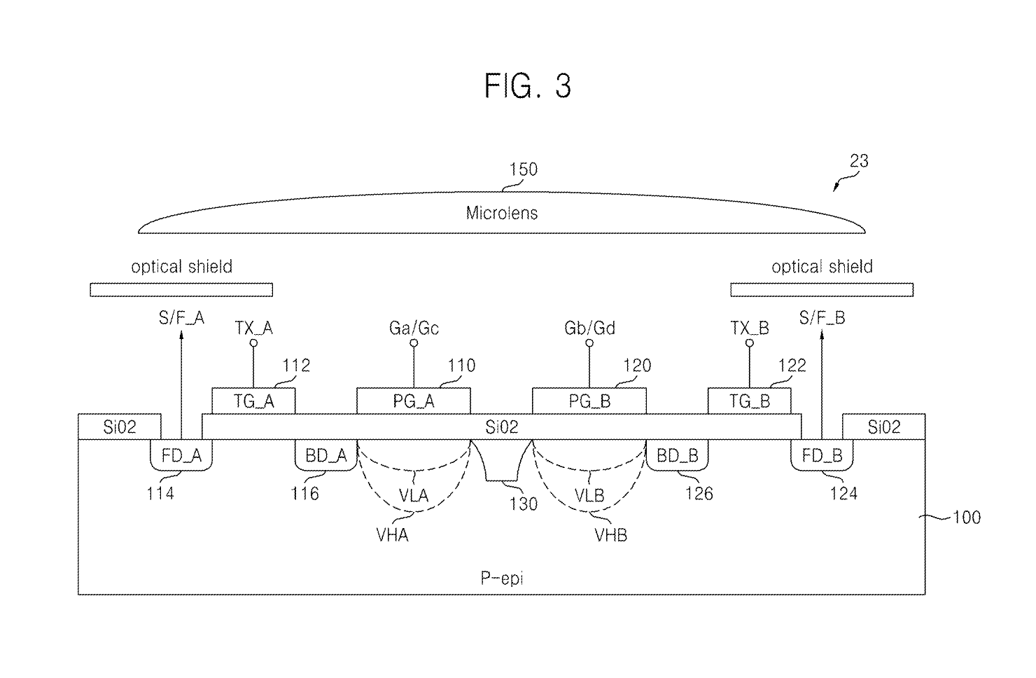

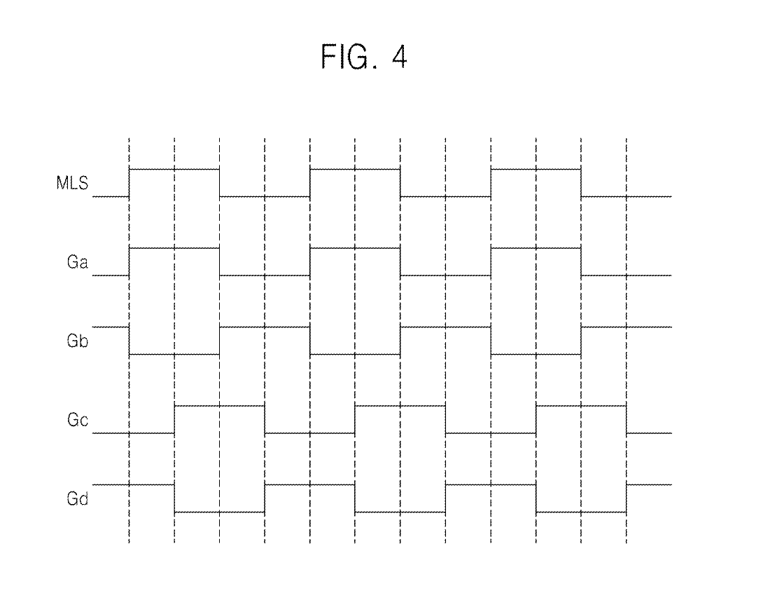

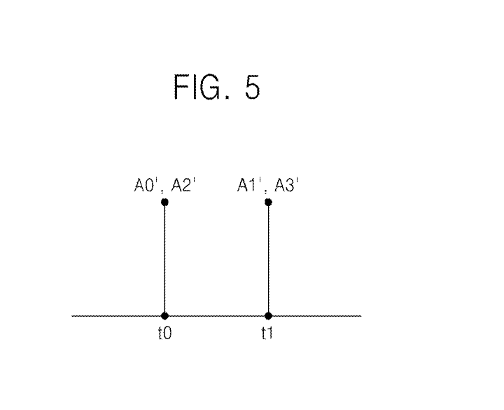

FIG. 1 is a block diagram of a depth sensor 10 according an example embodiment. FIG. 2 is a plan view of a 2-tap depth pixel 23 included in an array 22 illustrated in FIG. 1. FIG. 3 is a cross-sectional view of the 2-tap depth pixel 23 illustrated in FIG. 2, taken along the line III-III′. FIG. 4 is a timing chart of photo gate control signals for controlling photo gates 110 and 120 included in the 2-tap depth pixel 23 illustrated in FIG. 1. FIG. 5 is a timing chart for explaining a plurality of pixel signals sequentially detected using the 2-tap depth pixel 23 illustrated in FIG. 1.

Referring to FIGS. 1 through 5, the depth sensor 10 that can measure a distance or a depth using a time-of-flight (TOF) principle includes a semiconductor chip 20 which includes the array 22 in which a plurality of 2-tap depth pixels (detectors or sensors) 23 are arranged, a light source 32, and a lens module 34. The 2-tap depth pixels 23 may be replaced by 1-tap depth pixels.

Each of the 2-tap depth pixels 23 implemented in the array 22 in two dimensions includes a microlens 150 which increases the efficiency of light collection and optical shields which protect elements of each 2-tap depth pixel 23.

Each 2-tap depth pixel 23 also includes a plurality of the photo gates 110 and 120 (see FIG. 2). The photo gates 110 and 120 may be formed using transparent poly silicon. In other embodiments, the photo gates 110 and 120 may be formed using indium tin oxide (ITO or tin-doped indium oxide), indium zinc oxide (IZO), or zinc oxide (ZnO).

The photo gates 110 and 120 may transmit near infrared rays received through the lens module 34. Each 2-tap depth pixel 23 also includes a P-type substrate 100.

Referring to FIGS. 2 through 4, a first floating diffusion region 114 and a second floating diffusion region 124 are formed in the P-type substrate 100. The first floating diffusion region 114 may be connected to a gate of a first drive transistor S/F_A (not shown) and the second floating diffusion region 124 may be connected to a gate of a second drive transistor S/F_B (not shown). Each of the drive transistors S/F_A and S/F_B may function as a source follower. The floating diffusion regions 114 and 124 may be doped with N-type dopant.

A silicon oxide layer is formed on the P-type substrate 100. The photo gates 110 and 120 and transfer transistors 112 and 122 are formed on the silicon oxide layer. An isolation region 130 may be formed in the P-type substrate 100 to prevent photocharges generated respectively by the photo gates 110 and 120 in the P-type substrate 100 from influencing to each other. The P-type substrate 100 may be a P-doped epitaxial substrate and the isolation region 130 may be a P+-doped region.

The isolation region 130 may be implemented using shallow trench isolation (STI) or local oxidation of silicon (LOCOS).

For a first integration time, a first photo gate control signal Ga is provided to the first photo gate 110 and a second photo gate control signal Gb is provided to the second photo gate 120 (see FIG. 5).

In addition, a first transfer control signal TX_A for transmitting photocharges generated in the P-type substrate 100 below the first photo gate 110 to the first floating diffusion region 114 is provided to a gate of the first transfer transistor 112. A second transfer control signal TX_B for transmitting photocharges generated in the P-type substrate 100 below the second photo gate 120 to the second floating diffusion region 124 is provided to a gate of the second transfer transistor 122.

A first bridging diffusion region 116 may also be formed in the P-type substrate 100 between a portion below the first photo gate 110 and a portion below the first transfer transistor 112 and a second bridging diffusion region 126 may also be formed in the P-type substrate 100 between a portion below the second photo gate 120 and a portion below the second transfer transistor 122. The first and second bridging diffusion regions 116 and 126 may be doped with N-type dopant.

Photocharges are generated by optical signals input to the P-type substrate 100 through the photo gates 110 and 120. The 2-tap depth pixel 23 illustrated in FIG. 3 includes a microlens 150 formed above the photo gates 110 and 120, but it may not include the microlens 150 in other embodiments.

When the first transfer control signal TX_A at a first level (e.g., 1.0 V) is provided to the gate of the first transfer transistor 112 and the first photo gate control signal Ga at a high level (e.g., 3.3 V) is provided to the first photo gate 110, charges generated in the P-type substrate 100 gather below the first photo gate 110, which is referred to as first charge collection. The collected charges are transferred to the first floating diffusion region 114 directly (for instance, when the first bridging diffusion region 116 is not formed) or through the first bridging diffusion region 116 (for instance, when the first bridging diffusion region 116 is formed), which is referred to as first charge transfer.

Simultaneously, when the second transfer control signal TX_B at a first level (e.g., 1.0 V) is provided to the gate of the second transfer transistor 122 and the second photo gate control signal Gb at a low level (e.g., 0 V) is provided to the second photo gate 120, photocharges are generated in the P-type substrate 100 below the second photo gate 120 but are not transferred to the second floating diffusion region 124.

In FIG. 3, a reference character VHA denotes a region where potentials or photocharges are accumulated when the first photo gate control signal Ga at the high level is provided to the first photo gate 110 and a reference character VLB denotes a region where potentials or photocharges are accumulated when the second photo gate control signal Gb at the low level is provided to the second photo gate 120.

When the first transfer control signal TX_A at the first level (e.g., 1.0 V) is provided to the gate of the first transfer transistor 112 and the first photo gate control signal Ga at the low level (e.g., 0 V) is provided to the first photo gate 110, photocharges are generated in the P-type substrate 100 below the first photo gate 110 but are not transferred to the first floating diffusion region 114.

Simultaneously, when the second transfer control signal TX_B at the first level (e.g., 1.0 V) is provided to the gate of the second transfer transistor 122 and the second photo gate control signal Gb at the high level (e.g., 3.3 V) is provided to the second photo gate 120, charges generated in the P-type substrate 100 gather below the second photo gate 120, which is referred to as second charge collection. The collected charges are transferred to the second floating diffusion region 124 directly (for instance, when the second bridging diffusion region 126 is not formed) or through the second bridging diffusion region 126 (for instance, when the second bridging diffusion region 126 is formed), which is referred to as second charge transfer.

In FIG. 3, a reference character VHB denotes a region where potentials or photocharges are accumulated when the second photo gate control signal Gb at the high level is provided to the second photo gate 120 and a reference character VLA denotes a region where potentials or photocharges are accumulated when the first photo gate control signal Ga at the low level is provided to the first photo gate 110.

Charge collection and charge transfer, which occur when a third photo gate control signal Gc is provided to the first photo gate 110, is similar to the first charge collection and the first charge transfer which occur when the first photo gate control signal Ga is provided to the first photo gate 110.

In addition, charge collection and charge transfer, which occur when a fourth photo gate control signal Gd is provided to the second photo gate 120, is similar to the second charge collection and the second charge transfer which occur when the second photo gate control signal Gb is provided to the second photo gate 120.

Referring to FIG. 1, a row decoder 24 selects one row from among a plurality of rows in response to a row address output from a timing controller 26. Here, a row is a set of 2-tap depth pixels arranged in an X-direction in the array 22.

A photo gate controller 28 may generate a plurality of the photo gate control signals Ga, Gb, Gc, and Gd and provide them to the array 22 under the control of the timing controller 26.

As illustrated in FIG. 4, the difference between a phase of the first photo gate control signal Ga and a phase of the third photo gate control signal Gc is 90°. The difference between the phase of the first photo gate control signal Ga and a phase of the second photo gate control signal Gb is 180°. The difference between the phase of the first photo gate control signal Ga and a phase of the fourth photo gate control signal Gd is 270°.

A light source driver 30 may generate a clock signal MLS for driving the light source 32 under the control-of the timing controller 26.

The light source 32 emits a modulated optical signal to a target object 40 in response to the clock signal MLS. A light emitting diode (LED), an organic light emitting diode (OLED), an active-matrix organic light emitting diode (AMOLED), or a laser diode may be used as the light source 32. For clarity of the description, it is assumed that the modulated optical signal is the same as the clock signal MLS. The modulated optical signal may be a sine wave or a square wave.

The light source driver 30 provides the clock signal MLS or information about the clock signal MLS to the photo gate controller 28. Accordingly, the photo gate controller 28 generates the first photo gate control signal Ga having the same phase as the clock signal MLS and the second photo gate control signal Gb having a 180° phase difference from the clock signal MLS. In addition, the photo gate controller 28 generates the third photo gate control signal Gc having a 90° phase difference from the clock signal MLS and the fourth photo gate control signal Gd having a 270° phase difference from the clock signal MLS. The photo gate controller 28 and the light source driver 30 may operate in synchronization with each other. The modulated optical signal output from the light source 32 is reflected from the target object 40.

A plurality of reflected optical signals are input to the array 22 through the lens module 34. Here, the lens module 34 may include a lens and an infrared pass filter.

The depth sensor 10 includes a plurality of light sources arranged in circle around the lens module 34, but only one light source 32 is illustrated in FIG. 1 for clarity of the description.

The optical signals input to the array 22 through the lens module 34 may be demodulated by a plurality of sensors 23. In other words, the optical signals input to the array 22 through the lens module 34 may form an image.

Each of the 2-tap depth pixels 23 accumulates photoelectrons or photocharges for a desired (or, alternatively a predetermined) period of time, e.g., an integration time, in response to the photo gate control signals Ga through Gd and outputs pixel signals A0′ and A2′ and pixel signals A1′ and A3′, which are generated according to accumulation results, to the correlated double sampling (CDS)/analog-to-digital converting (ADC) circuit 36 via a first and second transfer transistors 112, 122 and the first and second floating diffusion regions 114, 124 respectively.

For instance, each 2-tap depth pixel 23 accumulates photoelectrons for a first integration time in response to the first photo gate control signal Ga and the second photo gate control signal Gb and outputs the first pixel signal A0′ and the third pixel signal A2′ generated according to accumulation results. In addition, the 2-tap depth pixel 23 accumulates photoelectrons for a second integration time in response to the third photo gate control signal Gc and the fourth photo gate control signal Gd and outputs the second pixel signal A1′ and the fourth pixel signal A3′ generated according to accumulation results.

A pixel signal Ak′ generated by the 2-tap depth pixel 23 is expressed by Equation 1:

$${A}_{k}^{′} = {\sum }_{n = 1}^{N} {a}_{k , n} \qquad ( 1 )$$

Here, when a signal input to the photo gate 110 or 120 of the 2-tap depth pixel 23 has a 0° phase difference from the clock signal MLS, k is 0. When the signal has a 90° phase difference from the clock signal MLS, k is 1. When the signal has a 180° phase difference from the clock signal MLS, k is 2. When the signal has a 270° phase difference from the clock signal MLS, k is 3.

“a_{k,n}” denotes the number of photoelectrons (or photocharges) generated in the 2-tap depth pixel 23 when an n-th gate signal is applied with a phase difference corresponding to “k” where “n” is a natural number and N=fm*Tint where “fm” is a frequency of the modulated optical signal and “Tint” is the integration time.

Referring to FIG. 5, each of the 2-tap depth pixels 23 detects the first pixel signal A0′ and the third pixel signal A2′ at a first detection point t0 in response to the first photo gate control signal Ga and the second photo gate control signal Gb and detects the second pixel signal A1′ and the fourth pixel signal A3′ at a second detection point t1 in response to the third photo gate control signal Gc and the fourth photo gate control signal Gd.

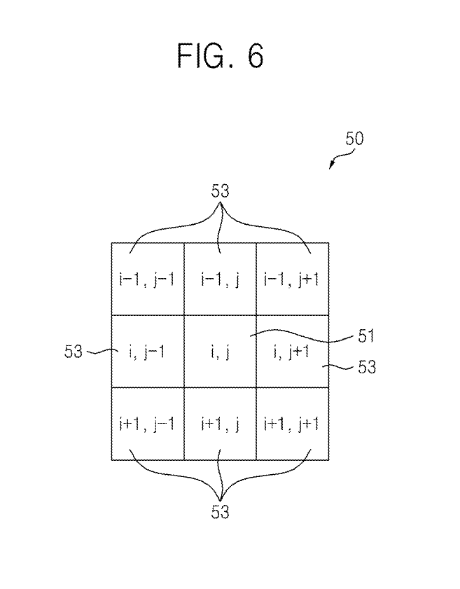

FIG. 6 is a block diagram of a pixel block 50 illustrated in FIG. 1. Referring to FIGS. 1 through 6, the pixel block 50 includes a depth pixel 51 and its neighbor depth pixels 53. The pixel block 50 serves as a filter mask defing the neighbor depth pixels 53 of the depth pixel. The filter mask is not limited to the shape or size shown in the figures.

The depth pixel 51 detects a plurality of depth pixel signals A0′(i,j), A1′(i,j), A2′(i,j), and A3′(i,j) in response to a plurality of the photo gate control signals Ga through Gd. The neighbor depth pixels 53 detect a plurality of neighbor depth pixel signals A0′(i−1j−1), A1′(i−1,j−1), A2′(i−1,j−1), A3′(i−1,j−1), . . . , A0′(i+1,j+1), A1′(i+1,j+1), A2′(i+1,j+1), A3′(i+1,j+1) in response to the photo gate control signals Ga through Gd. Here, “i” and “j” are natural numbers and are used to indicate the position of each pixel.

Referring to FIG. 1, under the control of the timing controller 26, a digital circuit, i.e., a correlated double sampling (CDS)/analog-to-digital converting (ADC) circuit 36 performs CDS and ADC on the pixel signals A0′, A2′, A1′, and A3′ output from the plurality of the 2-tap depth pixels 23 and outputs digital pixel signals A0, A1, A2, and A3.

For instance, the CDS/ADC circuit 36 performs CDS and ADC on the depth pixel signals A0′(i,j), A1′(i,j), A2′(i,j), and A3′(i,j) output from the depth pixel 51 and the neighbor depth pixel signals A0′(i−1,j−1), A1′(i−1,j−1), A2′(i−1,j−1), A3′(i−1,j−1), . . . , A0′(i+1,j+1), A1′(i+1,j+1), A2′(i+1,j+1), A3′(i+1,j+1) output from the neighbor depth pixels 53 and outputs digital depth pixel signals A0(i,j), A1(i,j), A2(i,j), and A3(i,j) and digital neighbor depth pixel signals A0(i−1,j−1), A1(i−1,j−1), A2(i−1,j−1), A3(i−1,j−1), . . . , A0(i+1,j+1), A1(i+1,j+1), A2(i+1,j+1), A3(i+1,j+1).

The digital pixel signals A0, A1, A2, and A3 are expressed by Equations 2 through 5:

A0≅α+β cos θ (2)

A2≅α−β cos θ (3)

A1≅α+β sin θ (4)

A3≅α−β sin θ (5)

where α indicates an amplitude and β indicates an offset. The offset is background intensity.

The amplitude α and the offset β are respectively expressed by Equations 6 and 7 using Equations 2 through 5.

α=(A0+A1+A2+A3)/4. (6)

$$β = \frac{\sqrt{{( A 3 - A 1 )}^{2} + {( A 2 - A 0 )}^{2}}}{2} . \qquad ( 7 )$$

The depth sensor 10 illustrated in FIG. 1 may also include a plurality of active load circuits for transmitting pixel signals output from a plurality of column lines in the array 22 to the CDS/ADC circuit 36.

A memory 37 may be implemented as a buffer. The memory 37 receives and stores the digital pixel signals A0, A1, A2, and A3 output from the CDS/ADC circuit 36.

For instance, the memory 37 receives and stores the digital depth pixel signals A0(i,j), A1(i,j), A2(i,j), and A3(i,j) and the digital neighbor depth pixel signals A0(i−1,j−1), A1(i−1,j−1), A2(i−1,j−1), A3(i−1,j−1), . . . , A0(i+1,j+1), A1(i+1,j+1), A2(i+1,j+1), A3(i+1,j+1).

When there are different distances Z₁, Z₂, and Z₃ between the depth sensor 10 and the target object 40, a digital signal processor (not shown) calculates a distance Z using the depth pixel information value p(i,j) and the neighbor depth pixel information values p(i−1,j−1), p(i−1,j), p(i−1,j+1), p(i,j−1), p(i,j+1), p(i+1,j−1), p(i+1,j), and p(i+1,j+1), which are output from the pixel information generator 38 or a defection correction filter 39.

For instance, when the modulated optical signal (e.g., the clock signal MLS) is cos ω t and an optical signal input to the 2-tap depth pixel 23 or an optical signal (e.g., A0, A1, A2, or A3) detected by the 2-tap depth pixel 23 is cos(ω t+θ), a phase shift or difference θ led by TOF is expressed by Equation 8:

θ=arctan((A3−A1)/(A2−A0)) (8)

where (A3−A1) indicates a first digital differential pixel signal and (A2−A0) indicates a second digital differential pixel signal. Accordingly, the distance Z from the light source 32 or the array 22 to the target object 40 is calculated using Equation 9:

Z=θ*C/(2*ω)=θ*C/(2*(2πf)) (9)

where C is the speed of light.

When the digital signal processor calculates the distance Z, an error may occur due to noise of a plurality of digital pixel signals (e.g., A0, A1, A2, and A3). Accordingly, the defect correction filter 39 for detecting and correcting defective pixels, as described in detail below, is desirable.

A pixel information generator 38 generates a depth pixel information value p(i,j) of the depth pixel 51 and neighbor depth pixel information values p(i−1,j−1), p(i−1,j), p(i−1,j+1), p(i,j−1), p(i,j+1), p(i+1,j−1), p(i+1,j), and p(i+1,j+1) of the respective neighbor depth pixels 53 using a plurality of the digital pixel signals A0 and A2 and A1 and A3.

The depth pixel information value p(i,j) of the depth pixel 51 and the neighbor depth pixel information values p(i−1,j−1), p(i−1,j), p(i−1,j+1), p(i,j−1), p(i,j+1), p(i+1,j−1), p(i+1,j), and p(i+1,j+1) of the respective neighbor depth pixels 53 are phase difference (θ) values, differential depth pixel signal values, offset (β) values, or amplitude (α) values.

The differential depth pixel signal values are first digital differential depth pixel signal values A31(i−1,j−1), A31(i−1,j), A31(i−1,j+1), A31(i,j−1), A31(i,j), A31(i,j−1), A31(i+1,j−1), A31(i+1,j), and A31(i+1,j+1) or second digital differential depth pixel signal values A20(i−1,j−1), A20(i−1,j), A20(i−1,j+1), A20(i,j−1), A20(i,j), A20(i,j+1), A20(i+1,j−1), A20(i+1,j), and A20(i+1,j+1).

The first digital differential pixel signal values A31(i−1,j−1), A31(i−1,j), A31(i−1,j+1), A31(i,j−1), A31(i,j), A31(i,j+1), A31(i+1,j−1), A31(i+1,j), and A31(i+1,j+1) are calculated by respectively subtracting second digital pixel signals A1(i−1,j−1), A1(i−1,j), A1(i−1,j+1), A1(i,j−1), A1(i,j), A1(i,j+1), A1(i+1,j−1), A1(i+1,j), and A1(i+1,j+1) detected by the depth pixels 51 and 53 from fourth digital pixel signals A3(i−1,j−1), A3(i−1,j), A3(i−1,j+1), A3(i,j−1), A3(i,j), A3(i,j+1), A3(i+1,j−1), A3(i+1,j), and A3(i+1,j+1) detected by the depth pixels 51 and 53 .

The second digital differential pixel signal values A20(i−1,j−1), A20(i−1,j), A20(i−1,j+1), A20(i,j−1), A20(i,j), A20(i,j+1), A20(i+1,j−1), A20(i+1,j), and A20(i+1,j+1) are calculated by respectively subtracting first digital pixel signals A0(i−1,j−1), A0(i−1,j), A0(i−1,j+1), A0(i,j−1), A0(i,j), A0(i,j+1), A0(i+1,j−1), A0(i+1,j), and A0(i+1,j+1) detected by the depth pixels 51 and 53 from third digital pixel signals A2(i−1,j−1), A2(i−1,j), A2(i−1,j+1), A2(i,j−1), A2(i,j), A2(i,j+1), A2(i+1,j−1), A2(i+1,j), and A2(i+1,j+1) detected by the depth pixels 51 and 53 .

The defect correction filter 39 arranges the neighbor depth pixel information values p(i−1,j−1), p(i−1,j), p(i−1,j+1), p(i,j−1), p(i,j−1), p(i+1,j−1), p(i+1,j), and p(i+1,j+1) of the respective neighbor depth pixels 53; compares the depth pixel information value p(i,j) of the depth pixel 51 with a reference value, which is one of the arranged neighbor depth pixel information values; and corrects the depth pixel information value p(i,j) according to a comparison result.

The defect correction filter 39 arranges the neighbor depth pixel information values p(i−1,j−1), p(i−1,j), p(i−1,j+1), p(i,j−1), p(i,j+1), p(i+1,j−1), p(i+1,j), and p(i+1,j+1) of the respective neighbor depth pixels 53 in descending or ascending order.

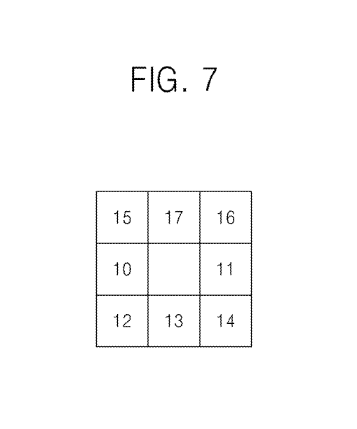

FIG. 7 is a diagram showing the phase difference (θ) values of the respective neighbor depth pixels 53. Referring to FIGS. 1 through 7, the phase difference (θ) values of the respective neighbor depth pixels 53 are 17, 16, 15, 14, 13, 12, 11, and 10 in descending order. Although the number of the neighbor depth pixels 53 is 8 in FIG. 7, it may change in other embodiments. Namely, the size and shape of the neighbor pixel mask may change.

The reference value may be either a first reference value PR1 or a second reference value PR2. The first reference value PR1 is one of the first through third values among the phase difference (θ) values arranged in descending order. For instance, the first reference value PR1 may be 16 in FIG. 7. The second reference value PR2 is one of the first through third values among the phase difference (θ) values arranged in ascending order. For instance, the second reference value PR2 may be 12 in FIG. 7. The first and second reference values PR1 and PR2 may be changed in different embodiments. Namely, the position or rank selected for the reference values may be changed.

The defect correction filter 39 replaces the depth pixel information value p(i,j) with the first reference value PR1 (i.e., pCorr(i,j)=PR1 where pCorr(i,j) is a corrected depth pixel information value) when the depth pixel information value p(i,j) is greater than the first reference value PR1. For instance, when the depth pixel information value p(i,j) is greater than the first reference value PR1 of 16 (e.g., when the depth pixel information value p(i,j) is 19) in FIG. 7, the defect correction filter 39 corrects the depth pixel information value p(i,j) to 16.

When the depth pixel information value p(i,j) is less than the first reference value PR1, the defect correction filter 39 keeps the depth pixel information value p(i,j) the same (i.e., pCorr(i,j)=p(i,j)) or replaces the depth pixel information value p(i,j) with the mean of the values between the first and second reference values PR1 and PR2 among the arranged values (e.g., pCorr(i,j)=(p4+p5+p6)/3 where p4, p5, and p6 are the fourth through sixth values among the values arranged in ascending order).

For instance, when the depth pixel information value p(i,j) is less than the first reference value PR1 of 16 (e.g., when the depth pixel information value p(i,j) is 15) in FIG. 7, the defect correction filter 39 maintains the depth pixel information value p(i,j) at 15 or replaces it with the mean of the values between the first and second reference values PR1 and PR2, i.e., (13+14+15)/3=14.

When the depth pixel information value p(i,j) is greater than the second reference value PR2, the defect correction filter 39 keeps the depth pixel information value p(i,j) the same (i.e., pCorr(i,j)=p(i,j)) or replaces it with the mean of the values between the first and second reference values PR1 and PR2 among the arranged values (e.g., pCorr(i,j))=(p4+p5+p6)/3).

For instance, when the depth pixel information value p(i,j) is greater than the second reference value PR2 of 12 (e.g., when the depth pixel information value p(i,j) is 13) in FIG. 7, the defect correction filter 39 maintains the depth pixel information value p(i,j) at 13 or replaces it with the mean of the values between the first and second reference values PR1 and PR2, i.e., (13+14+15)/3=14.

When the depth pixel information value p(i,j) is less than the second reference value PR2, the defect correction filter 39 replaces the depth pixel information value p(i,j) with the second reference value PR2 (i.e., pCorr(i,j)=PR2). For instance, when the depth pixel information value p(i,j) is less than the second reference value PR2 of 12 (e.g., when the depth pixel information value p(i,j) is 9) in FIG. 7, the defect correction filter 39 corrects the depth pixel information value p(i,j) to 12. The above-described operations can be performed with respect to the corrected pixel information value pCorr(i,j) through a return operation.

In the same manner, the neighbor depth pixel information values p(i−1,j−1), p(i−1,j), p(i−1,j+1), p(i,j−1), p(i,j+1), p(i+1,j−1), p(i+1,j), and p(i+1,j+1) of the respective neighbor depth pixels 53 may be corrected.

The memory 37, the pixel information generator 38, and the defect correction filter 39 may be implemented in an image signal processor. The depth sensor 10 and the digital signal processor may be implemented on a single chip.

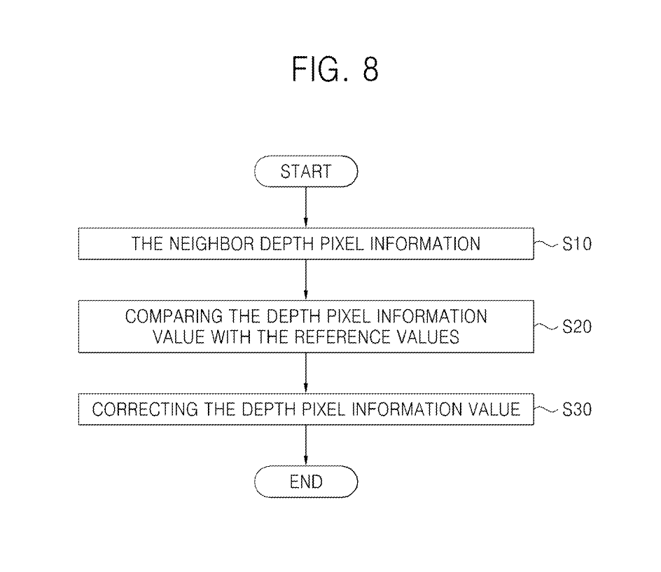

FIG. 8 is a flowchart of a defect correction method of the depth sensor 10 according to some embodiments of the present invention. Referring to FIGS. 1 through 8, the defect correction filter 39 arranges the neighbor depth pixel information values p(i−1,j−1), p(i−1,j), p(i−1,j+1), p(i,j−1), p(i,j+1), p(i+1,j−1), p(i+1,j), and p(i+1,j+1) of the respective neighbor depth pixels 53 in operation S10.

The defect correction filter 39 compares the depth pixel information value p(i,j) of the depth pixel 51 with the reference values PR1 and PR2, each of which is one of the arranged neighbor depth pixel information values in operation S20. The defect correction filter 39 corrects the h depth pixel information value p(i,j) according to a comparison result in operation S30.

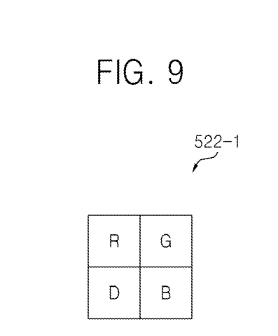

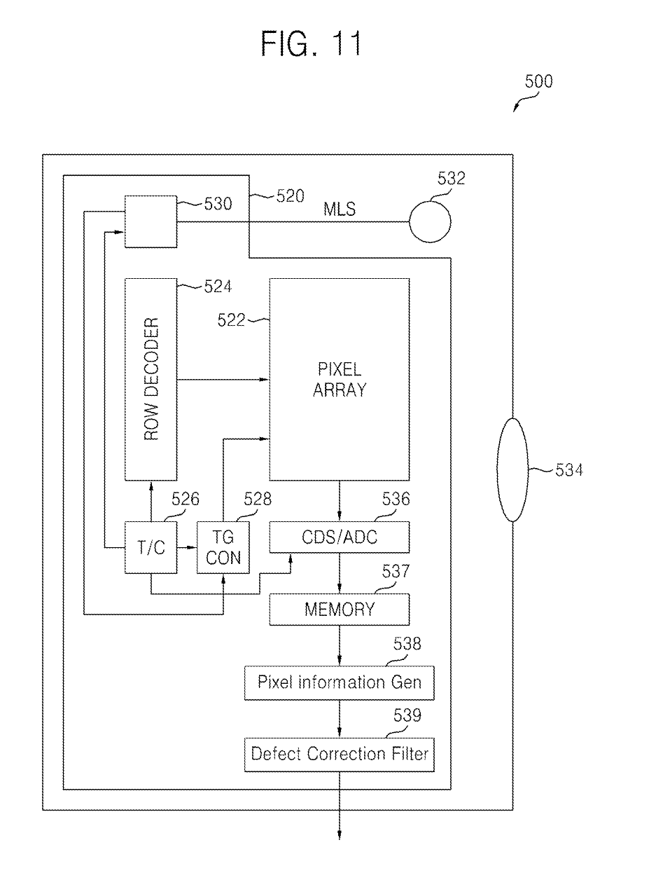

FIG. 9 is a diagram of a unit pixel array 522-1 of a three-dimensional (3D) image sensor according to an example embodiment. Referring to FIG. 9, the unit pixel array 522-1 forming a part of a pixel array 522 illustrated in FIG. 11 may include a red pixel R, a green pixel G, a blue pixel B, and a depth pixel D. The depth pixel D may be the depth pixel 23 having a 2-tap structure, as illustrated in FIG. 1, or a depth pixel (not shown) having a 1-tap structure. The red pixel R, the green pixel G, and the blue pixel B may be referred to as RGB color pixels.

The red pixel R generates a red pixel signal corresponding to wavelengths in a red range of a visible spectrum. The green pixel G generates a green pixel signal corresponding to wavelengths in a green range of the visible spectrum. The blue pixel B generates a blue pixel signal corresponding to wavelengths in a blue range of the visible spectrum. The depth pixel D generates a depth pixel signal corresponding to wavelengths in an infrared spectrum.

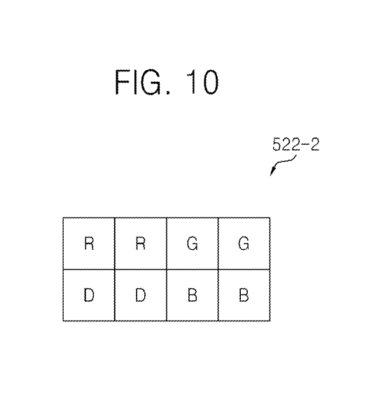

FIG. 10 is a diagram of a unit pixel array 522-2 of a 3D image sensor according to an example embodiment. Referring to FIG. 10, the unit pixel array 522-2 forming a part of the pixel array 522 illustrated in FIG. 11 may include two red pixels R, two green pixels G, two blue pixels B, and two depth pixels D.

The unit pixel arrays 522-1 and 522-2 illustrated in FIGS. 9 and 10 are as examples shown for clarity of the description. The pattern of a unit pixel array and pixels forming the pattern may vary with embodiments. For instance, the pixels R, G, and B illustrated in FIGS. 9 and 10 may be replaced by a magenta pixel, a cyan pixel, and a yellow pixel.

FIG. 11 is a block diagram of a 3D image sensor 500 according to an example embodiment. Here, the 3D image sensor 500 is a device that obtains 3D image information by combining a function of measuring depth information using the depth pixel D included in the unit pixel array 522-1 or 522-2 illustrated in FIG. 9 or 10 and a function of measuring color information (e.g., red color information, green color information, or blue color information) using each of the color pixels R, G, and B.

Referring to FIG. 11, the 3D image sensor 500 includes a semiconductor chip 520, a light source 532, and a lens module 534. The semiconductor chip 520 includes the pixel array 522, a row decoder 524, a timing controller 526, a photo gate controller 528, a light source driver 530, a CDS/ADC circuit 536, a memory 537, a pixel information generator 538, and a defect correction filter 539.

The operations and the functions of the row decoder 524, the timing controller 526, the photo gate controller 528, the light source driver 530, the CDS/ADC circuit 536, the memory 537, the pixel information generator 538, and the defect correction filter 539 illustrated in FIG. 11 are the same as those of the row decoder 24, the timing controller 26, the photo gate controller 28, the light source driver 30, the CDS/ADC circuit 36, the memory 37, the pixel information generator 38, and the noise reduction filter 39 illustrated in FIG. 1. Thus, detailed descriptions thereof will be omitted. The 3D image sensor 500 may also include a column decoder (not shown). The column decoder may decode column addresses output from the timing controller 526 and output column selection signals.

The row decoder 524 may generate control signals for controlling the operations of each pixel included in the pixel array 522, e.g., each of the pixels R, G, B, and D illustrated in FIG. 9 or 10.

The pixel array 522 includes the unit pixel array 522-1 or 522-2 illustrated in FIG. 9 or 10. For instance, the pixel array 522 includes a plurality of pixels. Each of the plurality of pixels may be a combination of at least two pixels among a red pixel, a green pixel, a blue pixel, a depth pixel, a magenta pixel, a cyan pixel, and a yellow pixel. The plurality of pixels may be respectively arranged at intersections between a plurality of row lines and a plurality of column lines in a matrix form. The memory 537, the pixel information generator 538, and the defect correction filter 539 may be implemented in the image signal processor.

At this time, the image signal processor may generate a 3D image signal based on the depth pixel information value p(i,j) and the neighbor depth pixel information values p(i−1,j−1), p(i−1,j), p(i−1,j+1), p(i,j−1), p(i,j+1), p(i+1,j−1), p(i+1,j), and p(i+1,j+1), which are output from the defect correction filter 539.

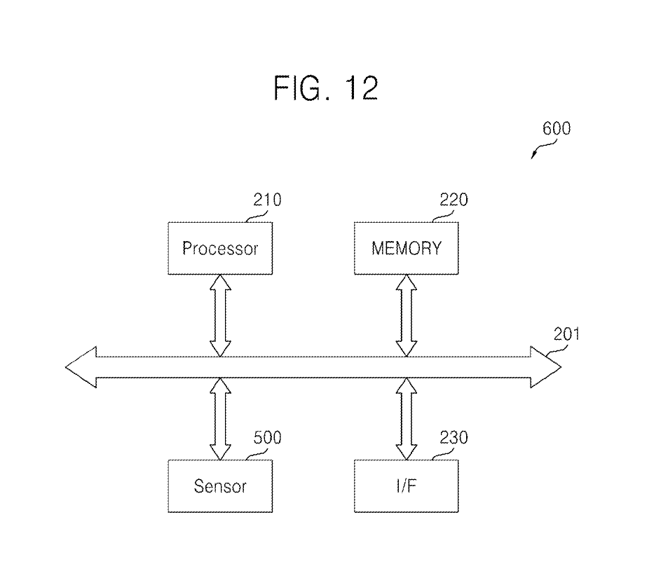

FIG. 12 is a block diagram of an image processing system 600 including the 3D image sensor 500 illustrated in FIG. 11. Referring to FIG. 12, the image processing system 600 may include the 3D image sensor 500 and a processor 210.

The processor 210 may control the operations of the 3D image sensor 500. For instance, the processor 210 may store a program for controlling the operations of the 3D image sensor 500. Alternatively, the processor 210 may access a memory (not shown) storing a program for controlling the operations of the 3D image sensor 500 and execute the program stored in the memory.

The 3D image sensor 500 may generate 3D image information based on a digital pixel signal (e.g., color information or depth information) under the control of the processor 210. The 3D image information may be displayed through a display (not shown) connected to an interface (I/F) 230. The 3D image information generated by the 3D image sensor 500 may be stored in a memory device 220 through a bus 201 under the control of the processor 210. The memory device 220 may be a non-volatile memory device.

The I/F 230 may input and output the 3D image information. The I/F 230 may be implemented as a wireless interface.

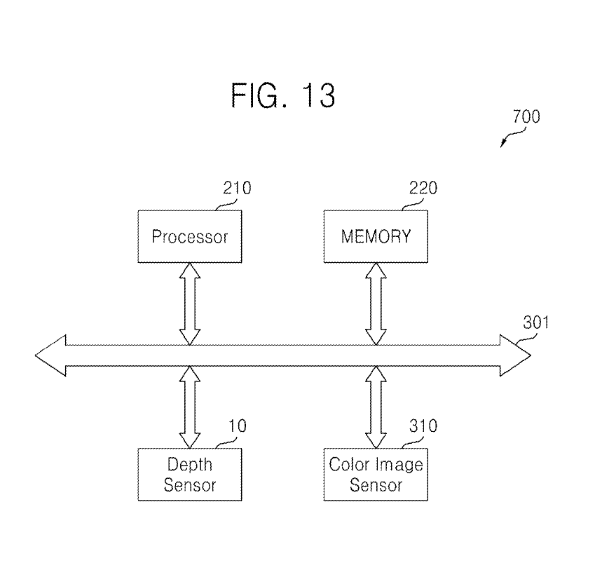

FIG. 13 is a block diagram of an image processing system 700 including a color image sensor 310 and the depth sensor 10 illustrated in FIG. 1. Referring to FIG. 13, the image processing system 700 may include the depth sensor 10, the color image sensor 310, and the processor 210.

The depth sensor 10 and the color image sensor 310 are illustrated in FIG. 13 to be physically separated from each other for clarity of the description, but they may physically share signal processing circuits with each other.

The color image sensor 310 may be an image sensor including a pixel array which includes a red pixel, a green pixel, and a blue pixel but does not include a depth pixel.

Accordingly, the processor 210 may generate 3D image information based on depth information estimated or calculated by the depth sensor 10 and color information (e.g., at least one among red information, green information, blue information, magenta information, cyan information, and yellow information) output from the color image sensor 310, and may display the 3D image information through a display. The 3D image information generated by the processor 210 may be stored in the memory device 220 through a bus 301.

The image processing system 600 or 700 illustrated in FIGS. 12 and 13 may be used for 3D distance meters, game controllers, depth cameras, and gesture sensing apparatuses.

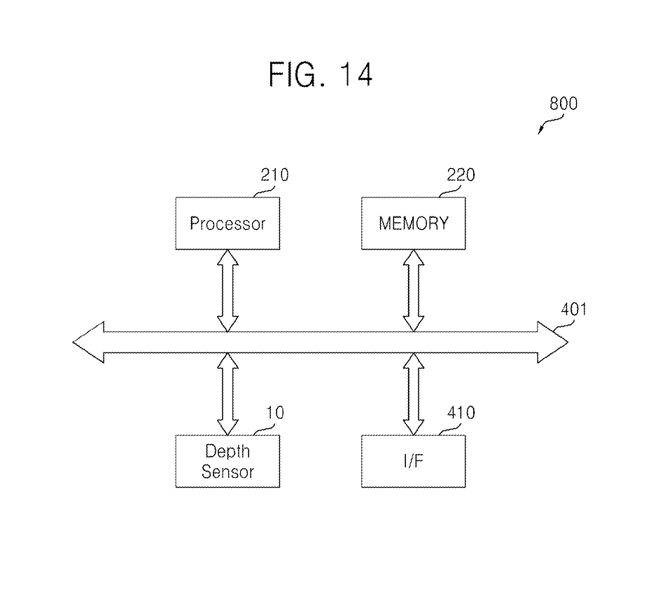

FIG. 14 is a block diagram of a signal processing system 800 including the depth sensor 10 according to an example embodiment. Referring to FIG. 14, the signal processing system 800, which simply functions as a depth (or distance) measuring sensor, includes the depth sensor 10 and the processor 210 controlling the operations of the depth sensor 10.

The processor 210 may calculate distance or depth information between the signal processing system 800 and an object (or a target) based on depth information (e.g., the depth pixel information value p(i,j)) output from the depth sensor 10. The distance or depth information calculated by the processor 210 may be stored in the memory device 220 through a bus 401.

As described above, according to some embodiments, a depth sensor detects and corrects defective pixels, thereby reducing pixel noise.

While the example embodiments have been particularly shown and described, it will be understood by those of ordinary skill in the art that various changes in forms and details may be made therein without departing from the spirit and scope of the inventive concepts as defined by the following claims.

1. A defect correction method for a depth sensor, the method comprising:
arranging a plurality of neighbor depth pixel information values of respective neighbor depth pixels, the neighbor depth pixels neighboring a depth pixel;
comparing a depth pixel information value of the depth pixel with a reference value, the reference value being one of the arranged neighbor depth pixel information values; and
correcting the depth pixel information value according to a comparison result.

2. The defect correction method of claim 1, wherein the depth pixel information value and the neighbor depth pixel information values are one of phase difference values, differential depth pixel signal values, offset values, and amplitude values,
wherein a plurality of first pixel signals are detected at a first detection point, a plurality of second pixel signals are detected at a second detection point, a plurality of third pixel signals are detected at a third detection point, and a plurality of fourth pixel signal are detected at a fourth detection point; and
wherein the differential depth pixel signal values are one of (1) first differential pixel signal values obtained by subtracting the plurality of second pixel signals detected at the second detection point from the plurality of fourth pixel signals detected at the fourth detection point among a plurality of pixel signals detected at the depth pixel and the neighbor depth pixels, and
(2) second differential pixel signal values obtained by subtracting the plurality of first pixel signals detected at the first detection point from the plurality of third pixel signals detected at the third detection point among the plurality of pixel signals detected at the depth pixel and the neighbor depth pixels.

3. The defect correction method of claim 1, wherein the reference value comprises one of a first reference value and a second reference value,
the first reference value is one of first through third values among the neighbor depth pixel information values arranged in descending order, and
the second reference value is one of first through third values among the neighbor depth pixel information values arranged in ascending order.

4. The defect correction method of claim 3, wherein the correcting the depth pixel information value comprises replacing the depth pixel information value with the first reference value when the depth pixel information value is greater than the first reference value.

5. The defect correction method of claim 3, wherein the correcting the depth pixel information value comprises one of (1) maintaining the depth pixel information value and (2) replacing the depth pixel information value with a mean of values between the first reference value and the second reference value among the arranged neighbor depth pixel information values when the depth pixel information value is less than the first reference value.

6. The defect correction method of claim 3, wherein the correcting the depth pixel information value comprises one of (1) maintaining the depth pixel information value and (2) replacing the depth pixel information value with a mean of values between the first reference value and the second reference value among the arranged neighbor depth pixel information values when the depth pixel information value is greater than the second reference value.

7. The defect correction method of claim 3, wherein the correcting the depth pixel information value comprises replacing the depth pixel information value with the second reference value when the depth pixel information value is less than the second reference value.

8. A depth sensor comprising:
a light source configured to emit modulated light to a target object;
a depth pixel and neighbor depth pixels, the neighbor depth pixels neighboring the depth pixel, the depth pixel and the neighbor depth pixels each configured to detect a plurality of pixel signals at different detection points according to light reflected from the target object;
a digital circuit configured to convert the plurality of pixel signals into a plurality of digital pixel signals;
a pixel information generator configured to generate a depth pixel information value of the depth pixel and a plurality of neighbor depth pixel information values of the respective neighbor depth pixels using the plurality of digital pixel signals; and
a defect correction filter configured to arrange the neighbor depth pixel information values, compare the depth pixel information value with a reference value, the reference being one of the arranged neighbor depth pixel information values, and the defect correction filter configured to correct the depth pixel information value according to a comparison result.

9. The depth sensor of claim 8, wherein the depth pixel information value and the neighbor depth pixel information values are one of phase difference values, differential depth pixel signal values, offset values, and amplitude values; and
wherein a plurality of first pixel signals are detected at a first detection point, a plurality of second pixel signals are detected at a second detection point, a plurality of third pixels signal are detected at a third detection point, and a plurality of fourth pixel signals are detected at a fourth detection point; and
wherein the differential depth pixel signal values are one of (1) first digital differential pixel signal values obtained by subtracting the plurality of second digital pixel signals detected at the second detection point from the plurality of fourth digital pixel signals detected at the fourth detection point among the plurality of digital pixel signals detected at the depth pixel and the neighbor depth pixels and (2) second digital differential pixel signal values obtained by subtracting the plurality of first digital pixel signals detected at the first detection point from the plurality of third digital pixel signals detected at the third detection point among the plurality of digital pixel signals detected at the depth pixel and the neighbor depth pixels.

10. The depth sensor of claim 8, wherein the reference value comprises one of a first reference value and a second reference value,
the first reference value is one of first through third values among the neighbor depth pixel information values arranged in descending order, and
the second reference value is one of first through third values among the neighbor depth pixel information values arranged in ascending order.

11. The depth sensor of claim 10, wherein the defect correction filter is configured to replace the depth pixel information value with the first reference value when the depth pixel information value is greater than the first reference value.

12. The depth sensor of claim 10, wherein the defect correction filter is configured to one of (1) maintain the depth pixel information value and (2) replace the depth pixel information value with a mean of values between the first reference value and the second reference value among the arranged neighbor depth pixel information values when the depth pixel information value is less than the first reference value.

13. The depth sensor of claim 10, wherein the defect correction filter is configured to one of (1) maintain the depth pixel information value and (2) replace the depth pixel information value with a mean of values between the first reference value and the second reference value among the arranged neighbor depth pixel information values when the depth pixel information value is greater than the second reference value.

14. The depth sensor of claim 10, wherein the defect correction filter is configured to replace the depth pixel information value with the second reference value when the depth pixel information value is less than the second reference value.

15. A signal processing system comprising:
a depth sensor; and
a processor configured to control an operation of the depth sensor,
wherein the depth sensor includes,
a light source configured to emit modulated light to a target object;
a depth pixel and neighbor depth pixels, the neighbor depth pixels neighboring the depth pixel, the depth pixel and the neighbor depth pixels each configured to detect a plurality of pixel signals at different detection points according to light reflected from the target object;
a digital circuit configured to convert the plurality of pixel signals into a plurality of digital pixel signals;
a pixel information generator configured to generate a depth pixel information value of the depth pixel and a plurality of neighbor depth pixel information values of the respective neighbor depth pixels using the plurality of digital pixel signals; and
a defect correction filter configured to arrange the neighbor depth pixel information values, compare the depth pixel information value with a reference value, the reference value being one of the arranged neighbor depth pixel information values, and the defect correction filter configured to correct the depth pixel information value according to a comparison result.

16. The signal processing system of claim 15, wherein the depth pixel information value and the neighbor depth pixel information values are one of phase difference values, differential depth pixel signal values, offset values, and amplitude values; and
wherein a plurality of first pixel signals are detected at a first detecting point, a plurality of second pixel signals are detected at a second detection point, a plurality of third pixel signals are detected at a third detection point, and a plurality of fourth pixel signals are detected at a fourth detection point; and
wherein the differential depth pixel signal values are one of (1) first digital differential pixel signal values obtained by subtracting the plurality of second digital pixel signals detected at the second detection point from the plurality of fourth digital pixel signals detected at the fourth detection point among the plurality of digital pixel signals detected at the depth pixel and the neighbor depth pixels and (2) second digital differential pixel signal values obtained by subtracting the plurality of first digital pixel signals detected at the first detection point from the plurality of third digital pixel signals detected at the third detection point among the plurality of digital pixel signals detected at the depth pixel and the neighbor depth pixels.

17. The signal processing system of claim 15, wherein the reference value comprises one of a first reference value and a second reference value,
the first reference value is one of first through third values among the neighbor depth pixel information values arranged in descending order, and
the second reference value is one of first through third values among the neighbor depth pixel information values arranged in ascending order.

18. The signal processing system of claim 17, wherein the defect correction filter is configured to replace the depth pixel information value with the first reference value when the depth pixel information value is greater than the first reference value.

19. The signal processing system of claim 17, wherein the defect correction filter is configured to one of (1) maintain the depth pixel information value and (2) replace the depth pixel information value with a mean of values between the first reference value and the second reference value among the arranged neighbor depth pixel information values when the depth pixel information value is less than the first reference value.

20. The signal processing system of claim 17, wherein the defect correction filter is configured to one of (1) maintain the depth pixel information value and (2) replace the depth pixel information value with a mean of values between the first reference value and the second reference value among the arranged neighbor depth pixel information values when the depth pixel information value is greater than the second reference value.

21.-29. (canceled)
